(19) United States
(12) Patent Application Publication
(10) Pub. No.: US 2021/0303427 A1
(43) Pub. Date: Sep. 30, 2021

(54) SYSTEM FOR TESTING A BLOCKCHAIN ENABLED DEVICE-UNDER-TEST

(71) Applicant: Rohde & Schwarz GmbH & Co. KG, Munich (DE)

(72) Inventor: Bernhard STERZBACH, Munich (DE)

(21) Appl. No.: 16/831,404

(22) Filed: Mar. 26, 2020

(51) Int. Cl. G06F 11/26; G06F 16/27; G06F 16/23

(52) U.S. Cl. CPC G06F 11/26; G06F 16/2379; G06F 16/27

(57) ABSTRACT

The invention relates to a system for testing a blockchain enabled device-under-test, comprising: a blockchain data unit configured to receive and/or generate blockchain data, an interface unit configured to transmit a signal encoding said blockchain data to the blockchain enabled device-under-test via a preferably wireless communication channel, and a control unit configured to selectively adjust transmission parameters of said signal or said communication channel preferably to simulate mobile network characteristics.

### TECHNICAL FIELD OF THE INVENTION

The invention relates to system for testing a blockchain enabled device-under-test and a test method for such a device-under-test.

### BACKGROUND OF THE INVENTION

Blockchain enabled devices are devices that can participate in a blockchain network, e.g. for storing data in the blockchain. Such devices are often connected to a public blockchain via a communication network, e.g. a mobile network, through which they receive and transmit data from and to the blockchain, respectively.

Such devices need to be tested under controlled conditions before first implementation or later during their lifecycle. The testing typically comprises a separate testing of general aspects of the device, e.g. its mobile communication components, and of the blockchain related components of the device.

Testing of the blockchain components is typically performed by means of public communication networks and using data from a public blockchain, especially after a first implementation of the device. However, such testing necessarily has an impact on the public blockchain. In particular, this can make repeatable testing under identical conditions impossible. Further, the blockchain data that is used for testing is limited to the data that is provided by the public blockchain. In addition, it is difficult to test how the communication network influences the device and its interaction with the blockchain.

Document WO 2019/072288 A2 discloses a testing platform for blockchain networks, wherein a test blockchain is provided by copying blocks of a production blockchain to a test blockchain container. Thereby, the test blockchain container has read-only access to the production blockchain. However, this approach does not allow a targeted modification of the blockchain data used for testing or of the communication network used for data transmission.

Thus, it is an objective to provide an improved system for testing a blockchain enabled device-under-test and an improved test method for such a blockchain enabled device-under-test, which avoid the above-mentioned disadvantages.

### SUMMARY OF THE INVENTION

The object of the present invention is achieved by the solution provided in the enclosed independent claims. Advantageous implementations of the present invention are further defined in the dependent claims.

According to a first aspect, the invention relates to a system for testing a blockchain enabled device-under-test, comprising a blockchain data unit configured to receive and/or generate blockchain data, an interface unit configured to transmit a signal encoding said blockchain data to the blockchain enabled device-under-test via a preferably wireless communication channel, and a control unit configured to selectively adjust transmission parameters of said signal or said communication channel preferably to simulate mobile network characteristics.

This achieves the advantage that the blockchain implementation of the device-under-test can be tested efficiently, in particular taking into account parameters of the mobile network.

The blockchain enabled device-under-test can be a measurement device, for instance a utility meter with built-in data transmission capabilities. The device-under-test can further be a mobile device or a stationary device, such as a vending machine or an ATM adapted for using cryptocurrencies. In particular, the device-under-test is an IoT (internet of things) device.

The system can be connected to an external blockchain, in particular a public blockchain and/or to participants of said external blockchain, e.g. via the internet. The blockchain data unit can be configured to receive the blockchain data from the external blockchain. The blockchain data can be public blockchain data.

The control unit can form or comprise a network simulation unit configured to simulate the mobile network characteristics.

The blockchain data unit, the interface unit and the control unit can be implemented in a shared testing hardware, e.g. a testing apparatus. Alternatively, components such as the blockchain data unit can be implemented in an external hardware, e.g. a cloud server, to which the testing hardware is connected, e.g. via an internet and/or a VPN connection.

The communication channel can be a wireless communication channel in a mobile communication network such as LTE or 5G. Preferably, the control unit is configured to adjust transmission parameters of said signal or the communication channel to simulate characteristics of a certain type of communication network or of participants in the communication network.

Preferably, the blockchain data comprises data accumulated in a real or a simulated blockchain or subsets thereof. In particular, the blockchain data comprises data which is conformant to a blockchain network protocol.

In an embodiment, the system further comprises an analyzation unit for receiving and analyzing a response signal of the device-under-test.

This achieves the advantage that the blockchain implementation of the device-under-test can be tested efficiently based on its response to the blockchain data.

Preferably, the interface unit is configured to receive the response signal via the communication channel and forward the response signal to the analyzation unit.

Alternatively, the analyzation unit can comprise a further interface which is connected to the device-under-test and configured to receive the response signal.

In an embodiment, the response signal comprises transaction data, wherein the analyzation unit is configured to verify the validity of said transaction data.

This achieves the advantage that the blockchain implementation of the device-under-test, for example its handling of cryptocurrencies, can be tested efficiently.

In an embodiment, the blockchain data transmitted to the device-under-test comprises valid blockchain data and/or invalid, in particular erroneous or faulty, blockchain data.

This achieves the advantage that the system can test how the device-under-test reacts to valid and invalid blockchain data, for example weather the device-under-test is capable to distinguish between the valid and invalid blockchain data.

In an embodiment, the blockchain data unit is configured to simulate a blockchain, wherein the blockchain data is based on the simulated blockchain.

This achieves the advantage that the blockchain data unit can generate the blockchain data efficiently. In particular, no external, e.g. public, blockchain is required to generate the blockchain data and the testing has no impact on the external blockchain. In addition, it can be tested weather the device-under-test can detect if blockchain data was generated by a simulated blockchain.

Preferably, the simulated blockchain comprises a simulated blockchain network or a component thereof.

In particular, the blockchain data unit and the analyzation unit are components of a blockchain simulation unit of the system.

In an embodiment, the blockchain data unit is configured to simulate at least one further blockchain user adding data to the simulated blockchain.

This achieves the advantage that the blockchain data unit can generate the blockchain data efficiently. In particular, the simulated blockchain, and thus the generated blockchain data, can be authentic and can take further block chain participants into account. Preferably, the at least one further blockchain user is a simulated participant of the simulated blockchain.

In an embodiment, selectively adjusting the transmission parameters of the signal comprises manipulating the signal on a physical level, in particular to simulate a signal strength, a signal fading, a signal interruption, or a signal-to-noise ratio of said signal.

This achieves the advantage that the communication functionality of the device can be tested efficiently.

In an embodiment, selectively adjusting the transmission parameters of the signal comprises manipulating the signal on a logical level, in particular to generate offset bits, erroneous bits or a bit-error-ratio in the blockchain data.

This achieves the advantage that the blockchain functionality of the device, in particular its handling of erroneous data, can be tested efficiently.

Preferably, the control unit can be configured to simultaneously manipulating the signal on the physical and the logical level, e.g. to simultaneously test communication and blockchain functionalities of the device. In addition, the control unit can be configured to simulate mobile network characteristics of the signal or the transmission channel.

In an embodiment, the system comprises a user interface for receiving a user input, wherein the blockchain data unit is configured to modify the received and/or generated blockchain data based on the user input prior to transmitting the signal to the device-under-test.

This achieves the advantage that suitable blockchain data for testing the device-under-test can be generated efficiently. In particular, the user can specifically modify the blockchain data to test certain aspects of the blockchain implementation of the device-under-test, e.g. its capabilities to identify erroneous blockchain data.

All the above-mentioned embodiments and/or optional features of the system for testing the blockchain enabled device-under test can be combined.

According to a second aspect, the invention relates to a test method for a blockchain enabled device-under-test, comprising:
receiving and/or generating blockchain data;
transmitting a signal encoding said blockchain data to the blockchain enabled device-under-test via a preferably wireless communication channel; and
selectively adjusting transmission parameters of said signal or said communication channel preferably to simulate mobile network characteristics.

This achieves advantage that the blockchain implementation of the device-under-test can be tested efficiently, in particular taking into account parameters of the mobile network.

In an embodiment, the test method further comprises:
receiving and analyzing a response signal of the device-under-test.

This achieves the advantage that the blockchain implementation of the device-under-test can be tested efficiently based on its response to the blockchain data.

In an embodiment, the response signal comprises transaction data, wherein the step of analyzing the response signal of the device-under-test comprises verifying the validity of said transaction data.

This achieves the advantage that the blockchain implementation of the device-under-test, for example its handling of cryptocurrencies, can be tested efficiently.

In an embodiment, the method comprises the step of:
simulating a blockchain, wherein the blockchain data is based on the simulated blockchain.

This achieves the advantage that the blockchain data unit can generate the blockchain data efficiently. In particular, no external, e.g. public, blockchain is required to generate the blockchain data. Therefore, the testing has no impact on a public blockchain.

In an embodiment, selectively adjusting the transmission parameters of the signal comprises manipulating the signal on a physical level, in particular to simulate a signal strength, a signal fading, a signal interruption, or a signal-to-noise ratio of said signal.

This achieves the advantage that the communication functionality of the device can be tested efficiently.

In an embodiment, selectively adjusting the transmission parameters of the signal comprises manipulating the signal on a logical level, in particular to generate offset bits, erroneous bits or a bit-error-ratio in the blockchain data.

This achieves the advantage that the blockchain implementation of the device, in particular its handling of erroneous data, can be tested efficiently.

Preferably, the signal manipulated on the physical and the logical level, e.g. to simultaneously test communication and blockchain functionalities of the device.

All the above-mentioned embodiments and/or optional features of the test method for the blockchain enabled device-under test can be combined.

In particular, the above description with regard to the system for testing the device-under-test according to the present invention is correspondingly valid for the test method for the device-under-test according to the present invention.

### BRIEF DESCRIPTION OF THE DRAWINGS

The invention will be explained in the followings together with the figures.

FIG. 1 shows a schematic diagram of a system for testing a blockchain enabled device-under-test according to an embodiment;

FIG. 2 shows a schematic diagram of a system for testing a blockchain enabled device-under-test according to an embodiment; and

FIG. 3 shows a schematic diagram of a test method for a blockchain enabled device-under-test according to an embodiment.

### DETAILED DESCRIPTION OF THE PREFERRED EMBODIMENTS

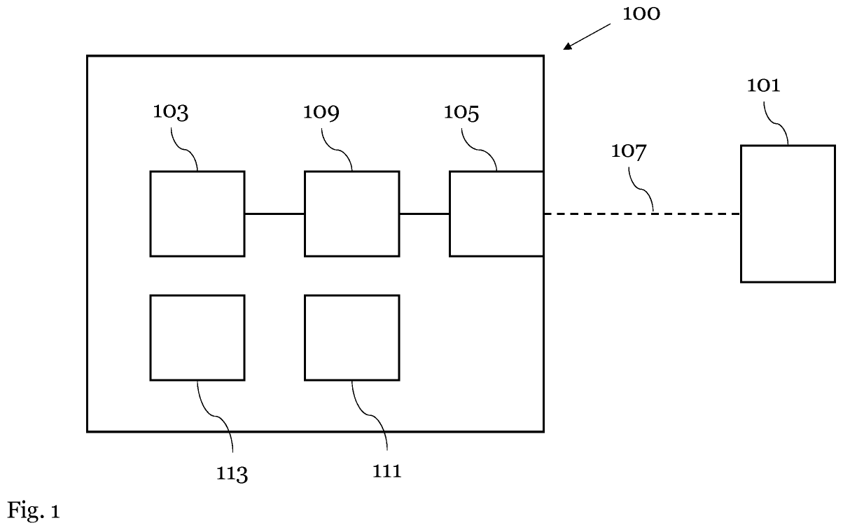

FIG. 1 shows a system 100 for testing a blockchain enabled device-under-test 101 according to an embodiment.

The system comprises a blockchain data unit 103 configured to receive and/or generate blockchain data, an interface unit 105 configured to transmit a signal encoding said blockchain data to the blockchain enabled device-under-test via a preferably wireless communication channel 107, and a control unit 109 configured to selectively adjust transmission parameters of said signal or said communication channel 107 preferably to simulate mobile network characteristics.

The blockchain enabled device-under-test 101 can be a measurement device, for instance a utility meter with built-in data transmission capabilities. The device-under-test 101 can further be a mobile device or a stationary device, such as a vending machine or an ATM adapted for using cryptocurrencies. In particular, the device-under-test 101 is an IoT (internet of things) device.

The communication channel 107 can be a wireless communication channel in a mobile communication network such as LTE or 5G. Preferably, the control unit 109 is configured to adjust transmission parameters of said signal or the communication channel 107 to simulate characteristics of a certain type of communication network or of participants in the communication network.

The control unit 109 can be configured to manipulate the signal transmitted over the communication channel 107 on a physical level. In particular, the control unit 109 can be configured to adjust at least one characteristic or metric of the wireless communication. For instance, the control unit 109 can be configured to simulate a signal strength, a signal fading, a signal interruption, or a signal-to-noise ratio of the signal and/or the communication channel 107. In this way, the communication capabilities of the device-under-test 101 can be tested for different predefined RF scenarios. It can also be tested, weather the device-under-test 101 can identify valid or fraudulent signals by their signal characteristics.

The control unit 109 can further be configured to manipulate the signal transmitted over the communication channel 107 on a logical level. For instance, the control unit 109 can be configured to generate offset bits, erroneous bits or a bit-error-ratio in the blockchain data. In this way, the blockchain capabilities of the device-under-test can be tested. In particular, the control unit 109 can be configured to manipulate the signal to convert valid blockchain data comprised in the signal, e.g. data from a public blockchain, to invalid blockchain data. It can then be tested, weather the device-under-test 101 can identify the blockchain data as invalid data.

The interface unit 115 can be configured to broadcast the signal continuously or on demand of the device-under-test 101.

The signal encoding the blockchain data can comprise the blockchain data. The device-under-test 101 can decode the blockchain data from the signal.

The control unit 109 can form or comprise a network simulation unit configured to simulate the mobile network characteristics. Preferably, the network simulation unit comprises at least two Internet Protocol interfaces, wherein a first Internet Protocol interface is configured to communicate with a database via Internet and a second Internet Protocol interface is configured to communicate with the device-under-test 101. In particular, the interface unit 105 corresponds to the second Internet Protocol interface of the network simulation unit.

The system 100, in particular the blockchain data unit 103, can be connected to a further blockchain, in particular a public blockchain, to receive the blockchain data. The system 100 can be connected to the further blockchain via the internet, in particular by means of a VPN connection. Thus, the blockchain data used for testing the device-under-test 101 can be real and authentic blockchain data.

The blockchain data transmitted to the device-under-test 101 can comprise valid blockchain data and/or invalid blockchain data. The invalid blockchain data can be erroneous, faulty, fraudulent or artificial blockchain data. The invalid blockchain data can be data as expected from an attacker entity against the blockchain network. In particular, the system 100 is adapted to test, weather the device-under-test 101 is capable to distinguish between valid and invalid blockchain data.

Preferably, the system 100 further comprise an analyzation unit 111 for receiving and analyzing a response signal of the device-under-test.

The interface unit 105 can be configured to receive a response signal from the device-under-test via the communication channel 107 and forward the response signal to the analyzation unit 111. Alternatively, the analyzation unit 111 can comprise a further interface which is connected to the device-under-test 101 and configured to receive the response signal.

In an alternative embodiment, the analyzation unit 111 can be a component of the device-under-test 101. In this way, the response of the device-under-test 101 to the blockchain data can be analyzed by the device itself.

The response signal can comprise transaction data. The analyzation unit 111 can be configured to verify the validity of said transaction data. In particular, the analyzation unit 111 is configured to verify if the transaction data is authentic or fake.

The analyzation unit 111 can further be configured to log the blockchain related activity of the device-under-test 101, in particular the response signal, and to protocol a conformance verification of said blockchain related activity. In particular, the analyzation unit 111 comprises a security tester and/or a protocol conformance tester.

The blockchain data unit 103, the interface unit 105, the control unit 109 and or the analyzation unit 111 can be implemented in a shared testing hardware, e.g. a testing apparatus. Alternatively, components such as the blockchain data unit 103 can be implemented in an external hardware, e.g. a cloud server, to which the testing hardware is connected.

The system 100 can further comprise an optional user interface 113 which is configured to receive user input. The user interface can be connected to the blockchain data unit 103 and/or the control unit 109. A user can input data on the user interface to modify the received or generated blockchain data and/or to modify the adjustment of transmission parameters of the signal or the communication channel 107.

The blockchain data unit 103, the analyzation unit 111 and/or the control unit 109 can be implemented in a processing unit or separate processing units of the system 100.

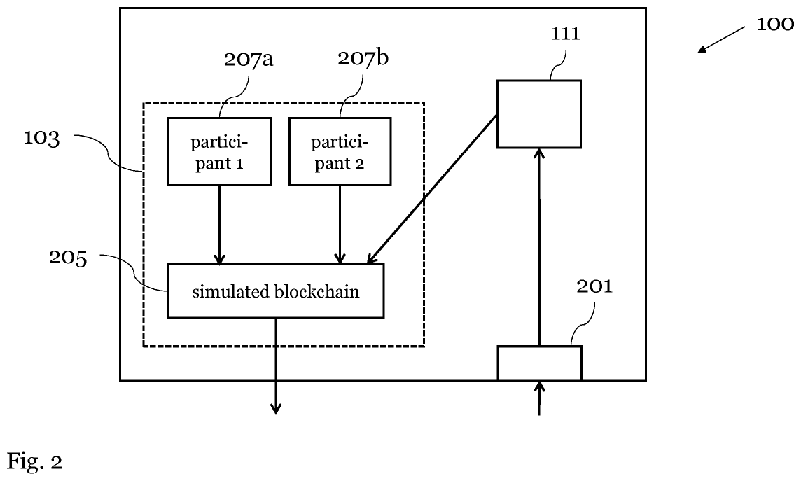

FIG. 2 shows a schematic diagram of the system 100 for testing a blockchain enabled device-under-test 101 according to another embodiment.

The blockchain the system comprises the blockchain data unit 103. The blockchain data unit 103 can be configured to generate a simulated blockchain 205, wherein the blockchain data for testing the device 101 is based on the simulated blockchain 205. Preferably, the blockchain data is data from the simulated blockchain 205 or a subset of the simulated blockchain 205. The simulated blockchain 205 can comprise data that resembles data from a real blockchain.

The blockchain data unit 103 can further be configured to simulate further blockchain users 207a-b that add data, in particular transaction data, to the simulated blockchain 205. In particular, the blockchain data unit 103 is configured to simulate actions of the further blockchain users 207a-b which are either related or unrelated to the actions of the device-under-test 101. The simulated actions of the further blockchain users 207a-b can be correct, incorrect or fraudulent actions. Thus, the simulated blockchain can resemble a real blockchain, e.g. a public blockchain, with other, potentially fraudulent, participants.

In particular, the blockchain data unit 103 is configured to extend real or simulated blockchain data with data based on actions of the device-under-test 101 and/or with simulated actions other blockchain users 207a-b.

The system 100 as shown in FIG. 2 further comprises an interface 201. The interface 201 can be configured to receive the response signal from the device-under test 101.

The interface 201 can correspond to the interface unit 105, as shown in FIG. 1. Alternative, the interface 201 can be a separate interface of the system 100 that is connected to the device-under-test, e.g. a wireless or a wire bound interface.

The interface 201 can be configured to forward the response signal to the analyzation unit 111. The analyzation unit 111 can be configured to analyze the response signal. In an embodiment, the analyzation unit 111 comprises the interface 201 for receiving the response signal.

The analyzation unit 111 can be configured to add data to the simulated blockchain based on the response signal. Thus, the simulated blockchain can resemble a real blockchain with the device-under-test 101 as blockchain participant that adds data to this blockchain.

In particular, the response signal comprises transaction data which represents blockchain data, and the analyzation unit 111 is configured to add the transaction data to the simulated blockchain. The blockchain data unit 103 can be configured to confirm the addition of the transaction data to the simulated blockchain 205.

The blockchain data unit 103 can be configured to generated further blockchain data following the receipt of the response signal, in particular following adding data based on the response signal to the simulated blockchain 205. This further data can be transmitted to the device-under-test 101 by means of a further signal, and a further response signal of the device-under-test 101 can be analyzed by the analyzation unit 111. In this way, an interaction between the device-under-test 101 and the simulated blockchain 205 can be analyzed for testing the blockchain implementation of the device-under-test 101 under realistic conditions.

The blockchain data unit 103 can further be configured to receive data representing blockchain data from another source, e.g. from the further blockchain connected to the system 100. This data can be added to the simulated blockchain 205 or forwarded to the device-under-test 101.

Preferably, the system 100, in particular the blockchain data unit 103, can be operated in a simulation mode and in a verification mode for testing the device-under-test 101:

In the simulation mode, all blockchain related communication can be handled within the system 100 preferably by means of the above mentioned simulated blockchain 205. In this mode, all relevant parameters of the blockchain protocol and of the network peer behavior can be adjusted when generating the blockchain data.

Preferably, the following parameters can be adjusted: network load (i.e. the amount of incoming transactions unrelated to device-under-test 101 activity), latency times (e.g. time delay until network peers react to device-under-test 101 activity, e.g. by confirming device-under-test actions), consensus mechanism simulation parameters (e.g. percentage of rogue peers), and difficulty settings for proof-of-work based protocols.

In the verification mode, the blockchain related communication can be forwarded to/from the public internet, in particular from the further blockchain mentioned above. The communication, especially the communication originated by the device-under-test 101, i.e. the response signal, can be logged and protocolled by the system 100, in particular by the analyzation unit 111, for verifying its conformance.

In an embodiment, the system 100 can be used to test multiple devices-under-test as peers within the simulated blockchain 205 or a real blockchain.

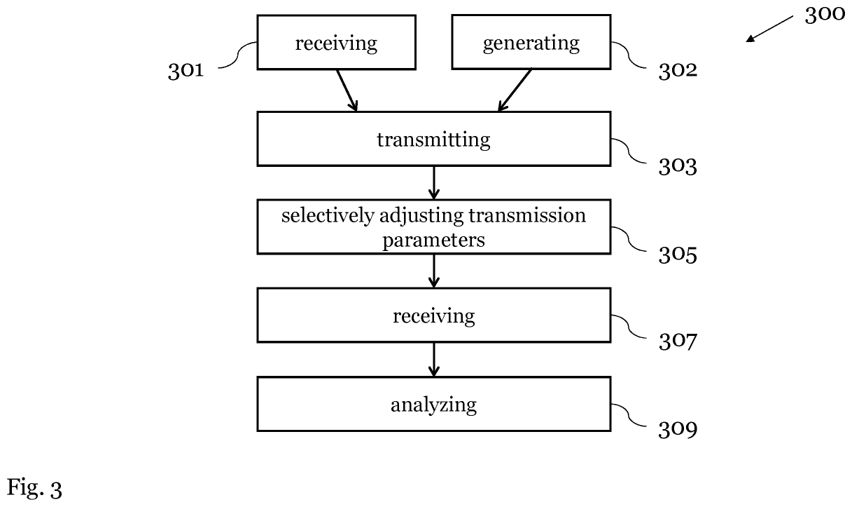

FIG. 3 shows a schematic diagram of a test method 300 for a blockchain enabled device-under-test 101 according to an embodiment.

The method 300 comprises the steps of:
receiving 301 and/or generating 302 blockchain data;
transmitting 303 a signal encoding said blockchain data to the blockchain enabled device-under-test 101 via the preferably wireless communication 107 channel; and
selectively adjusting 305 transmission parameters of said signal or said communication channel 107 preferably to simulate mobile network characteristics.

Preferably, the test method 300 further comprises the steps of:
receiving 307 the response signal from the device-under-test 101; and
analyzing 309 said response signal.

The response signal can comprise transaction data. The step of analyzing 309 the response signal can comprises verifying the validity of the transaction data.

Preferably, the test method 300 comprises the further step of: simulating a blockchain, wherein the blockchain data sent to the device-under-test 101 is based on the simulated blockchain.

In an embodiment, selectively adjusting the transmission parameters of the signal comprises manipulating the signal on a physical level, in particular to simulate a signal strength, a signal fading, a signal interruption, or a signal-to-noise ratio of said signal.

In another embodiment, selectively adjusting the transmission parameters of the signal comprises manipulating the signal on a logical level, in particular to generate offset bits, erroneous bits or a bit-error-ratio in the blockchain data.

The system 100 shown in FIG. 1 or 2 can be configured to execute the test method 300. In particular, the test method 300 is a method for testing the device-under-test 101.

All features of all embodiments described, shown and/or claimed herein can be combined with each other.

1. A system for testing a blockchain enabled device-under-test, comprising:
a blockchain data unit configured to receive and/or generate blockchain data,
an interface unit configured to transmit a signal encoding said blockchain data to the blockchain enabled device-under-test via a preferably wireless communication channel, and
a control unit configured to selectively adjust transmission parameters of said signal or said communication channel preferably to simulate mobile network characteristics.

2. The system according to claim 1, further comprising an analyzation unit for receiving and analyzing a response signal of the device-under-test.

3. The system according to claim 2, wherein the response signal comprises transaction data, wherein the analyzation unit is configured to verify the validity of said transaction data.

4. The system according to claim 1, wherein the blockchain data transmitted to the device-under-test comprises valid blockchain data and/or invalid, in particular erroneous or faulty, blockchain data.

5. The system according to claim 1, wherein the blockchain data unit is configured to simulate a blockchain, wherein the blockchain data is based on the simulated blockchain.

6. The system according to claim 5, wherein the blockchain data unit is configured to simulate at least one further blockchain user adding data to the simulated blockchain.

7. The system according to claim 1, wherein selectively adjusting the transmission parameters of the signal comprises manipulating the signal on a physical level, in particular to simulate a signal strength, a signal fading, a signal interruption, or a signal-to-noise ratio of said signal.

8. The system according to claim 1, wherein selectively adjusting the transmission parameters of the signal comprises manipulating the signal on a logical level, in particular to generate offset bits, erroneous bits or a bit-error-ratio in the blockchain data.

9. The system according to claim 1, wherein the system comprises a user interface for receiving a user input, wherein the blockchain data unit is configured to modify the received and/or generated blockchain data based on the user input prior to transmitting the signal to the device-under-test.

10. A test method for a blockchain enabled device-under-test, comprising:
receiving and/or generating blockchain data;
transmitting a signal encoding said blockchain data to the blockchain enabled device-under-test via a preferably wireless communication channel; and
selectively adjusting transmission parameters of said signal or said communication channel preferably to simulate mobile network characteristics.

11. The test method for according to claim 10, further comprising:
receiving and analyzing a response signal of the device-under-test.

12. The test method according to claim 11, wherein the response signal comprises transaction data, wherein the step of analyzing the response signal of the device-under-test comprises verifying the validity of said transaction data.

13. The test method according to claim 10, further comprising the step of:
simulating a blockchain, wherein the blockchain data is based on the simulated blockchain.

14. The test method according to claim 10, wherein selectively adjusting the transmission parameters of the signal comprises manipulating the signal on a physical level, in particular to simulate a signal strength, a signal fading, a signal interruption, or a signal-to-noise ratio of said signal.

15. The test method according to claim 10, wherein selectively adjusting the transmission parameters of the signal comprises manipulating the signal on a logical level, in particular to generate offset bits, erroneous bits or a bit-error-ratio in the blockchain data.
